(19) United States
(12) Patent Application Publication
(10) Pub. No.: US 2017/0282189 A1
(43) Pub. Date: Oct. 5, 2017

(54) PLANT AND PROCESS FOR THE RECOVERY OF WIRES FROM CAR FLUFF

(71) Applicant: SGM Gantry S.p.A., Manerbio (BS) (IT)

(72) Inventor: Danilo MOLTENI, Manerbio (BS) (IT)

(21) Appl. No.: 15/473,960

(22) Filed: Mar. 30, 2017

(30) Foreign Application Priority Data
Apr. 1, 2016 (IT) 102016000033582

(51) Int. Cl. B02C 23/14; B03C 1/30; B03C 1/23

(52) U.S. Cl. CPC B02C 23/14; B03C 1/23; B03C 1/30

(57) ABSTRACT

A plant for the treatment of car fluff is disclosed having one or more magnetic iron separators, followed by one or more eddy current separators that receive the negative coming from the magnetic iron separators, followed by one or more inductive sensor-based recovery separators that receive the negative coming from the eddy current separators, followed by at least two inductive sensor-based polishing separators respectively calibrated for the separation of stainless steel and copper wires arranged for receiving the material separated by the inductive sensor-based recovery separators, an unravelling shredder also being arranged between the latter and the polishing separator(s) calibrated for the separation of copper wires.

### CROSS-REFERENCE TO RELATED APPLICATIONS

This application claims the benefit of Italian Patent Application No. 102016000033582 filed Apr. 1, 2016, the contents of which are incorporated herein by reference.

### FIELD OF THE INVENTION

The present invention relates to the recovery of metals from scrap, and in particular to a plant and process for improving the rate of concentration of the electric wires recovered from the material defined as car fluff.

### BACKGROUND OF THE INVENTION

It is known that at the end of their lives, cars and also other industrial and domestic products of large size and essentially ferrous composition, are ground with large hammershredder shredders (so-called car shredders) which reduce them to pieces sized less than 150 mm so as to obtain ferrous scrap.

At the exit of these shredders, the mixed ground material undergoes an action of iron removal by means of strong electromagnetic drums in order to recover and clean up the ferromagnetic steel (so-called proler), which represents about 70% of the total and is sold to steel shredders to be melted and reused. The remaining approximately 30% that is discarded from said electromagnetic drums, called car fluff, is essentially composed of plastics, rubbers, polyurethane foams, glass, aluminum, copper, zinc, zinc alloy, lead, stainless steel, electrical wires, stone residues, oxides of iron and some parts of ferromagnetic steel lost during the recovery of the proler.

The car fluff is then treated with appropriate rotating and/or vibrating screens to subdivide it into sizes suitable for the treatments that you want to use for the separation and recovery of metals. These sizes are typically defined as follows:

Fine: indicatively under 16 mm and typically represents approximately 35% by weight of the total car fluff;

Median: approximately 16 to 40 mm and typically represents approximately 30% by weight of the total car fluff;

Large: indicatively between 40 and 120 mm and typically represents approximately 28% by weight of the total car fluff;

Oversize: indicatively between 120 and 150 mm and typically represents about 2% by weight of the total car fluff.

Each fraction of the car fluff thus divided according to its size is treated in appropriate plants for the recovery of metals, except for the Oversize fraction which is treated manually, or sent back to the car shredder or even discarded without any metal recovery treatment. The plant and the process according to the invention are specifically intended for the treatment of the Large fraction but can be used also for the treatment of the Median fraction.

In traditional plants the various stations/treatment steps can be summarized as follows.

I. Deferrization: by means of one or more magnetic iron separators for the recovery of the residual ferromagnetic steel still present in the car fluff and which can represent about 2.5% by weight of the total.
II. Main recovery of non-ferrous metals: by means of one or more eddy current separators for the recovery of a mixture of non-ferrous metals with a prevailing presence of aluminum, such mixed material being defined Zorba in the field on the basis of the definition specified by the American association ISRI (Institute of Scrap Recycling Industries, www.isri.org).
III. Recovery separation of non-ferrous metals: by means of one or more inductive sensor-based separators (so-called sensor-based separators) equipped with pneumatic or, rarely, mechanic ejection devices for the recovery of non-ferrous metals which for their characteristics are hardly recovered by the eddy current separators, namely the stainless steel and the copper electric wires (naked or still covered by their insulating sheaths).
IV. Polishing separation of non-ferrous metals: by means of one or more inductive sensor-based separators, like the previous recovery separators, whose function is to further concentrate the metals recovered by said recovery separators.

A drawback of conventional plants resides in the fact that normally it is not possible to obtain for the copper wires a concentration by weight (p) of more than 70-80% because, in the course of the treatment from the shredder onwards, the copper wires tend to tangle and retain in the various tangles light inert materials such as plastic, rubber, fabric, foam etc. which have a specific gravity much lower than the copper wires, whereby they typically equal or exceed the volume of the wires themselves.

This causes the commercial value of the copper content in such material to undergo a sharp decline because under such conditions it is difficult to sell it as recycled material to end users, and rather is sold as waste containing copper to buyers who in turn must process it again, often manually, in order to concentrate it to appropriate values.

### SUMMARY OF THE INVENTION

The object of the present invention is to provide a plant and a process that overcome the above-mentioned drawback. This object is achieved by means of a plant and a process in which between the recovery separator(s) and the polishing separator(s) for wires there is arranged a further shredder, referred to as “unravelling shredder”, which does not have the task of completely grinding the material but only of ginning it and breaking it up. Other advantageous features are listed in the dependent claims.

The fundamental advantage of the present plant and process is therefore to be able to better separate in the polishing step the inert materials and the wires so unravelled, in order to arrive at a concentration of the wires p>90% significantly higher than the 70-80% that can be achieved without the unravelling shredder. Under these conditions the copper wires can be sold at a fair price to end users and have no problem finding buyers for export since they can no longer be regarded as waste.

Another important advantage of the above plant and process is given by the simplicity and low cost, which makes it reliable and also suitable for the upgrading of existing plants.

### BRIEF DESCRIPTION OF THE DRAWINGS

Further advantages and characteristics of the plant and process according to the present invention will become apparent to those skilled in the art from the following detailed description of two embodiments thereof with reference to the accompanying drawings in which:

FIG. 1 is a flow diagram schematically showing a first embodiment of the invention; and

FIG. 2 is a flow diagram schematically showing a second embodiment of the invention.

### DETAILED DESCRIPTION OF THE INVENTION

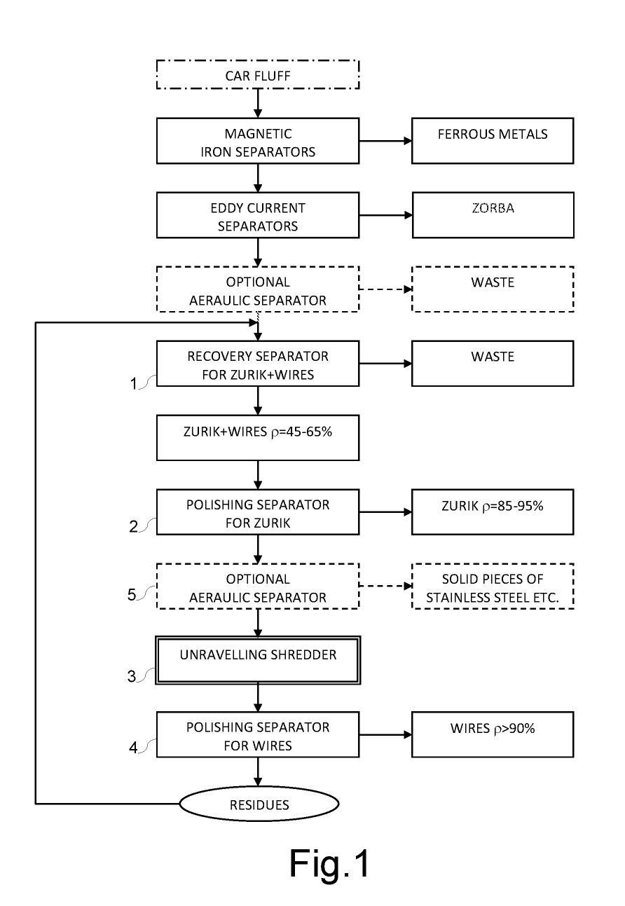

Referring to FIG. 1 and to what was mentioned above about the stations/treatment steps, there is seen that a plant/process according to a first embodiment of the present invention conventionally includes in a first part magnetic iron separators and eddy current separators for the removal from car fluff of ferrous metals and Zorba, followed possibly by an aeraulic separator which divides the material between a light fraction containing waste material and a heavy fraction in which the copper wires and the pieces of stainless steel are concentrated to about 10% (this division into light and heavy fraction can have also take place before the iron removal at the beginning of the process).

The remaining material is then treated in a second part by at least one recovery separator and at least two polishing separators whose operating principle is based on the recognition of metal objects by means of an inductive sensors system and on the separation (ejection) of said metal objects by means of air jets, synchronized by an electronic system, which divert their trajectory and allow their physical separation from the treated material flow.

Note that an inductive sensor-based separator can be calibrated to separate only the copper wires or only the pieces of stainless steel or both simultaneously, in which case the work mode is defined all metals recovery. In the case where the separator is calibrated only for the separation of the copper wires the work mode is defined wire recovery, while in the case where it is calibrated only for the separation of pieces of stainless steel the work mode is defined Zurik recovery, with the term Zurik which corresponds to a concentrate of mixed metal with a prevailing presence of stainless steel according to the definition specified by the American association ISRI (Institute of Scrap Recycling Industries, www.isri.org).

Since the recovery separators and the polishing separators are of the same type, it is clear that the above-mentioned calibration alternatives and the definitions of the work modes are valid for both the recovery and the polishing steps, although in the latter step the material is usually treated only in Zurik polishing and wire polishing mode but not in all metals polishing mode.

Furthermore, it is obvious that the case of using multiple inductive sensor-based separators in a same station/step is understood to refer to separators positioned one after the other where each separator receives and works the negative of the previous separator, i.e. the fraction of material not ejected by the previous separator. This allows the further recovery of metals either missed by previous separators (in all metals recovery mode) or intentionally left by the preceding separator in the case of multiple separators calibrated in Zurik recovery/polishing or wire recovery/polishing mode that work in cascade.

Typically, the presence of copper wires and pieces of stainless steel in the Large fraction of the car fluff is respectively about 0.75% and 1% of the total, and the concentration of the copper wires and pieces of stainless steel present in the mixed metallic material recovered by the first recovery separator 1 is usually 45-65%. This material is then treated by at least one polishing separator 2 calibrated for the separation of pieces of stainless steel only (Zurik mode) to bring the concentration of these pieces of stainless steel to 85-95%. The negative, i.e. the fraction of the material that is not expelled by separator 2, normally is treated by at least one polishing separator 4 calibrated for the separation of copper wires only (wire mode) to bring their concentration to 70-80%.

To improve this result, the innovative aspect of the present invention relates to the addition of a unravelling shredder 3 between the polishing separators 2 and 4, so that separator 4 operates on a material free from wire tangles thus managing to obtain a concentration of wire ρ>90%.

The unravelling shredder 3 is advantageously of reduced size and cost given the limited amount of material that it must treat, approximately less than 2% with respect to the total of the car fluff and corresponding to 0.6% of the total value of the material entering the car shredder. For this purpose, therefore, a low-speed (less than 60 rev/min) and high-torque shredder is preferably used which can be single-shaft or double-shaft with counter-rotating shafts. The elements which act on the material to be treated are generally blades or hooked discs with a variable number of hooks, mounted on one or two shafts driven by an electric or hydraulic motor with a power of the order of 75-120 KW (an example of a suitable shredder is the DUAL-SHEAR® M85 of SSI Shredding Systems of Wilsonville, Oreg., USA).

Note that in unravelling a tangle of threads and inert material it could happen to release also a piece of stainless steel or other hard bulky material that had remained caught in the tangle, therefore shredder 3 is preferably also equipped with a clutch that stops it thus allowing the operator to remove the polluting piece without causing damage to the shredder. To limit such an occurrence there may also be provided an additional aeraulic separator 5, placed upstream from shredder 3, which divides the material between a sucked light fraction in which the copper wires are included and a heavy fraction containing the unwanted heavy pieces of stainless steel or other that could block shredder 3.

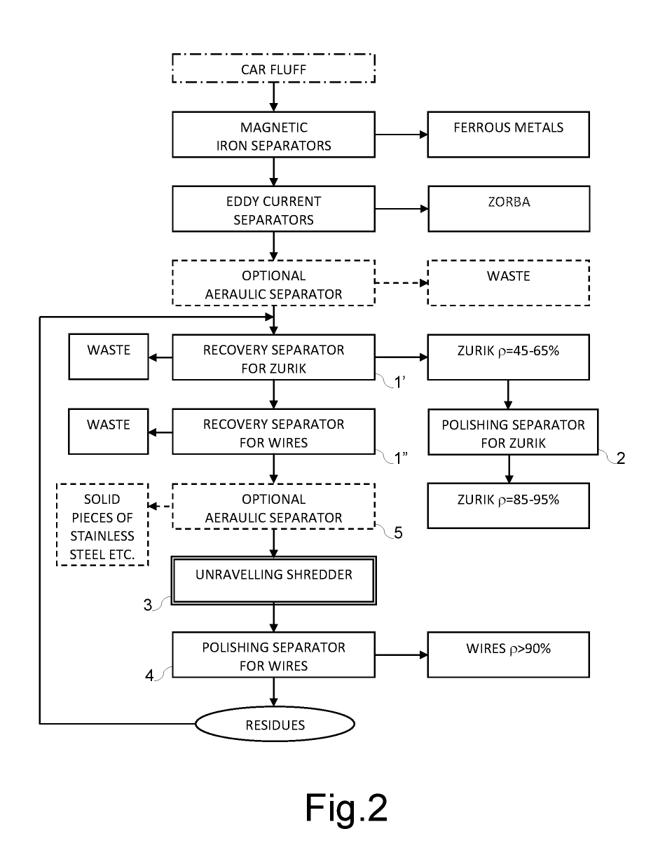

The second embodiment illustrated in FIG. 2 differs from the first embodiment only for the fact that the unravelling shredder 3, which is always immediately upstream from the polishing separator 4 for wires, instead of receiving the material from the polishing separator 2 for Zurik receives it from a recovery separator 1″ for wires. In fact in the recovery station/step the material is not treated in all metals recovery mode but rather first by a recovery separator 1′ in Zurik recovery mode and then by a recovery separator 1″ in wire recovery mode.

Therefore from the first separator 1′ there is directly obtained Zurik with ρ=45-65% which is then treated in a polishing separator 2 for Zurik bringing it to a concentration ρ=85-95%, while from the second separator 1″ there is obtained the material containing the wires that is sent to the unravelling shredder 3 (with possible passage through aeraulic separator 5) before being treated in the polishing separator 4 for wires.

The steps of the process for the treatment of car fluff carried out in the plant described above can therefore be summarized as follows:

a) iron removal, by means of one or more magnetic separators;
b) main recovery of non-ferrous metals, by means of one or more eddy current separators that treat the negative resulting from the preceding step;
c) recovery separation of residual non-ferrous metals, typically stainless steel and copper wires, by means of one or more inductive sensor-based separators that treat the negative resulting from the preceding step;
d) polishing separation of the material separated in the previous step, by means of at least one inductive sensor-based separator calibrated for the separation of stainless steel;
e) breaking up of the material separated in step c) or of the negative resulting from the preceding step, by means of an unravelling shredder;
f) polishing separation of the material broken up in the preceding step, by means of at least one to inductive sensor-based separator calibrated for the separation of copper wires.

The method may further comprise a step of separation of the material into a light fraction and a heavy fraction by means of an aeraulic separator immediately prior to step a) and/or step c) and/or step e). The step c) can also be divided into two sub-steps c′) and c″) in which the recovery of stainless steel and copper wires is carried out separately.

It is obvious that the embodiments of the plant/process according to the invention described and illustrated above are just examples susceptible of various modifications. In particular, the exact number, type and arrangement of the inductive sensor-based separators can vary depending on the specific application, e.g. the order in the sequence of recovery separators 1′, 1″ can be reversed.

1. A car fluff treatment plant comprising:
a) one or more magnetic iron separators;
b) one or more eddy current separators that receive the negative coming from said magnetic iron separators;
c) one or more inductive sensor-based recovery separators that receive the negative coming from said eddy current separators;
d) at least two inductive sensor-based polishing separators respectively calibrated for the separation of stainless steel and of copper wires, said inductive sensor-based polishing separators being arranged to receive the material separated by said inductive sensor-based recovery separators
wherein the plant further includes an unravelling shredder arranged between the inductive sensor-based recovery separators and the inductive sensor-based polishing separator(s) calibrated for the separation of copper wires.

2. The plant according to claim 1, wherein the unravelling shredder is a single-shaft or double-shaft shredder of the low-speed high-torque type, optionally with a power in the range of 75-120 KW.

3. The plant according to claim 1, wherein the unravelling shredder is provided with a clutch that stops it in case it receives a piece too hard to be processed therein.

4. The plant according to claim 1, wherein the unravelling shredder receives the negative coming from an inductive sensor-based polishing separator calibrated for the separation of stainless steel.

5. The plant according to claim 1, wherein the unravelling shredder receives the material separated by an inductive sensor-based recovery separator calibrated for the separation of copper wires.

6. The plant according to claim 1, wherein it further includes one or more aeraulic separators arranged immediately upstream from the magnetic iron separators and/or the inductive sensor-based recovery separators and/or the unravelling shredder.

7. A process for the treatment of car fluff with a plant according to claim 1 comprising:
a) iron removal, by means of one or more magnetic separators;
b) main recovery of non-ferrous metals, by means of one or more eddy current separators that treat the negative resulting from step a);
c) recovery separation of residual non-ferrous metals, by means of one or more inductive sensor-based recovery separators that treat the negative resulting from step b);
d) polishing separation of the material separated in step b), by means of at least one inductive sensor-based polishing separator calibrated for the separation of stainless steel; and
e) polishing separation of the material separated in step c) or of the negative resulting from step b), by means of at least one inductive sensor-based polishing separator calibrated for the separation of copper wires;
wherein it further includes a step d′) of breaking up by means of an unravelling shredder of the material to be treated in step e).

8. The process according to claim 7, further comprising a step of separation of the material into a light fraction and a heavy fraction by means of an aeraulic separator immediately before step a) and/or step c) and/or step d′).

9. The process according to claim 7, wherein step c) is divided into two sub-steps c′) and c″) in which the recovery of stainless steel and copper wires is carried out separately, by means of two or more inductive sensor-based recovery separators respectively calibrated for the separation of said materials.

10. The process according to claim 7, wherein the treated material has a size between 16 and 120 mm.

11. The process according to claim 7, wherein the treated material has a size between 40 and 120 mm.
